(19) United States
(12) Patent Application Publication
(10) Pub. No.: US 2005/0056080 A1
(43) Pub. Date: Mar. 17, 2005

(54) Blood monitoring system

(76) Inventors: Christopher Scott Lucci, West Mifflin, PA (US); Mark J. Gartner, Pittsburgh, PA (US)

Correspondence Address: BLYNN L. SHIDELER;THE BLK LAW GROUP, 3500 BROKKTREE ROAD, SUITE 200, WEXFORD, PA, 15090, US

(21) Appl. No.: 10/910,776

(22) Filed: Aug. 2, 2004

Related U.S. Application Data
(60) Provisional application No. 60/491,906, filed on Aug. 1, 2003.

(51) Int. Cl. G01N 29/02

(52) U.S. Cl. 73/24.01

(57) ABSTRACT

A method and apparatus for measuring blood gas concentrations and partial pressures, in real time, using a pneumatic detector to indicate partial pressure variations in the blood gas.

### CROSS-REFERENCE TO RELATED APPLICATIONS

This application claims the benefit of U.S. Provisional Patent Application Ser. No. 60/491,906, filed Aug. 1, 2003, entitled “Blood Monitoring System”.

### FIELD OF THE INVENTION

The present invention generally relates to concentration monitoring and, more particularly, to an apparatus and method for measuring cardiopulmonary bypass patient perfusion status and adequacy in real time.

### BRIEF DESCRIPTION OF THE PRIOR ART

Perfusion adequacy is a critical parameter in patients requiring cardiopulmonary bypass (CPB). Perfusionists use mixed venous blood saturation and periodic blood gas analysis supplemented by clinical experience, to assess a patient's overall perfusion status. Commonly measured blood gases include O₂ and CO₂.

Periodic blood gas analysis forms a time-delayed basis of assessing perfusion adequacy during CPB, and typically requires a blood gas analyzer (BGA) that consumes a blood sample. A BGA typically involves the use of disposable supplies, and requires some time to complete the assay. Such blood gas monitoring methodologies remain the de-facto standard despite high cost, inconvenience, and inability to provide real-time concentrations and partial pressures of blood gases.

Conventional Clark cell electrochemical technology may be used to determine an O₂ concentration and partial pressure in the blood of a patient. Oxygen diffuses through a semi-permeable gas membrane from the blood sample into an internal electrolyte solution contained within the sensor and is reduced at the sensor cathode. The oxygen reduction current is proportional to the dissolved oxygen concentration. Other techniques used to measure oxygen paramagnetically include optical fluorescence techniques, platinum electrodes in high temperature ceramic materials, magnetic wind devices, and pulsating field units. A field-proven method is based upon the movement of a dumbbell-shaped nitrogen-filled glass sphere assembly positioned within a magnetic field. Since oxygen is highly paramagnetic, it is strongly attracted to this magnetic field and impinges on the sphere assembly—causing the sphere assembly to rotate. The amount of sphere assembly rotation is measured with a LED/photodiode circuit and is a function of oxygen concentration.

Similar to O₂ measurement methodologies, several strategies have been developed to measure the presence of carbon dioxide in various media ranging from Severinghaus electrodes to spectroscopic techniques. Electrode-based techniques typically measure the partial pressure of CO₂ in blood via ion-selective electrode potentiometry. CO₂ concentrations are calculated from the measured potential via the Nernst equation. Gaseous CO₂ content, such as that required in analysis of human breath, is usually measured using infrared techniques since CO₂ is a molecule exhibiting a dipole moment in modes of molecular vibration. The molecule can relax from an excited vibration state by radiating electromagnetic energy in the infrared. By a similar process, a CO₂ molecule can be excited into an excited vibration state by absorbing infrared energy at the same wavelength. While several absorption bands exist for CO₂, absorption is usually measured using absorption bands between one and ten microns.

While many methods are available to measure CO₂ absorption phenomenon and determine CO₂ concentration in various background gases, most techniques are based upon optical path obscuration and rely on the collection of infrared energy. The amount of signal measured by the detector is inversely proportional to the concentration of gas in the sample path that absorbs energy at a wavelength selected either by filter or tuning of the source. The largest optical signal occurs when there is no absorbing gas in the optical path. These transmissivity-based analyzers typically exhibit repeatability problems, experience offset drift requiring frequent recalibration, and are vulnerable to changes in the optical path which are unrelated to gas absorption (e.g. source degradation and window obscuration).

Other blood gas monitoring technologies that measure O₂ and CO₂ content in expired breath (e.g. anesthesiology and indirect calorimetry) remain very costly and complex, prohibiting their widespread use in areas other than the intended application. These devices typically need frequent calibration to compensate for drift and other sources of error further complicate their routine use. Furthermore, specific information currently used by perfusionists, such as VCO₂, VO₂, pO₂, and pCO₂, along with corrections for background agents such as isoflorane, are not provided in real-time.

A recent attempt to devise a system with some capability to provide blood gas analysis, such as pCO₂ data, in real time is discussed in “Oxygenator Exhaust Capnography as an Index of Arterial Carbon Dioxide Tension During Cardiopulmonary Bypass Using a Membrane Oxygenator”, O'Leary et al., British Journal of Anesthesia, 82 (6); 843-6 (1999), herein incorporated by reference in its entirety. However, the O'Leary paper concludes that the attachment of an anesthesia machine to the exhaust steam of an extracorporeal blood oxygenator failed to provide a method of measuring blood pCO2 levels accurately. Furthermore, units such as the Terumo CDI 500 are very expensive, require extensive calibration, and exhibit limitations in basic sensor accuracy over normal operating conditions such as during mild hypothermia commonly induced during procedures involving CPB.

Another approach for real-time measurement of CO2 in a fluid is described in “Sampling Method Makes On-Stream IR Analysis Work”, Wilkes, Jr., Industrial Research and Development, September 1982, hereby incorporated by reference in its entirety. The Wilkes, Jr. article does not contemplate using pneumatic sensors to detect blood gas concentrations and associated partial pressures or using pneumatic sensors to calculate a pCO₂ gap.

In summary, monitoring blood gas concentrations and partial pressures in a patient undergoing CPB is critical to assessing perfusion adequacy and reducing post-operative morbidity. Real-time results are necessary.

### SUMMARY OF THE INVENTION

The present invention contemplates an apparatus and at least one method that can help solve the problem of real-time assessment of perfusion adequacy during CPB.

One preferred embodiment of an gas measuring device according to the present invention generally includes a body defining a cavity, wherein the cavity has a sealed finite volume; an optional fluid inlet fluidly connected to the cavity; a pneumatic detector, such as a microphone or photo-acoustic sensor, fluidly connected to the cavity; an IR source, such as a thermal emitter, optically connected to the cavity. Other components include a valve, such as one or more solenoid valves fluidly connected to the fluid inlet and the fluid outlet; a blood oxygenator exhaust fluidly connected to the fluid inlet, a signal amplifier electrically connected to the microphone, an analog to digital converter electrically connected to the signal amplifier or directly connected to the pneumatic detector without the signal amplifier, a digital signal processor electrically connected to the analog to digital converter, and an interference filter positioned adjacent to the body to create the sealed finite volume in one embodiment.

The present invention may also be used to determine blood gas concentrations, partial gas pressures, and a state of perfusion of a patient. One preferred method includes the steps of: exhausting at least one fluid, such as a liquid or gas, from a fluid transfer device such as an extracorporeal membrane oxygenator; containing a fixed volume of the at least one fluid; exposing the fixed volume of the at least one fluid to anIR or other excitation source; and detecting a pressure change in the fixed volume of the at least onefluid. The step of exposing the fixed volume of the at least one fluid to the excitation source may further include the step of irradiating the fixed volume of the at least one fluid with infrared radiation having a wavelength equal to an absorption wavelength of at least one gas present in the fluid. The step of detecting the pressure change in the fixed volume of the at least one fluid may include the step of creating an analog signal via a pneumatic sensor, such as a microphone or a photo-acoustic sensor. Other steps may include: amplifying the analog signal, converting the analog signal to a digital signal, sending the digital signal to a digital signal processor, converting the digital signal to a gas concentration via a look-up table, polynomial, or some other conversion algorithm, determining a partial pressure of the at least one gas; storing the concentration and partial pressure, and displaying the concentration and partial pressure in real time on a CRT or other display device. If the fluid is carbon dioxide, the step of determining the partial pressure of the carbon dioxide may further include the step of calculating a partial pressure of carbon dioxide according to some algorithm or equation.

In addition, the present invention can help determine a so-called pCO₂ gap, or the difference between the arterial partial pressure of CO₂ and the systemic tissue level partial pressure of CO₂. The pCO₂ gap is thought to be responsible for post-operative morbidity in patients that otherwise appear to have undergone normal and adequate CPB support during open-heart procedures and post-operative extracorporeal membrane oxygenation (ECMO).

A method according to the present invention may include the steps of exhausting at least one fluid from a fluid transfer device; containing a fixed volume of the at least one fluid; exposing the fixed volume of the at least one fluid to an excitation source; determining a first partial pressure of at least one gas in the fluid in real-time; determining a second partial pressure of the at least one gas via a blood gas analyzer, an ATR device, or an ATR device that includes a pneumatic sensor; comparing a difference between first partial pressure and the second partial pressure, each correlated by time, to determine a gap; and displaying the gap to an observer. Another step is adjusting patient parameters until the gap is approximately zero.

### BRIEF DESCRIPTION OF THE DRAWINGS

FIG. 1 is schematic view of an apparatus and system according to the present invention;

FIG. 2 is a partial cross-sectional side view of a gas measurement device according to the present invention;

FIG. 3 is a top view of a block portion of the gas measurement device;

FIG. 4 is a partially exploded top view of a partial gas measurement device according to the present invention, with optical filters removed and microphones obscured;

FIG. 5 is a side view of the block shown in FIG. 3;

FIG. 6 is an end view of the block shown in FIGS. 3 and 5; and

FIG. 7 is a side view of an ATR device with a gas measurement device added.

### DETAILED DESCRIPTION OF THE INVENTION

U.S. Provisional Patent Application Ser. No. 60/491,906, filed Aug. 1, 2003, entitled “Blood Monitoring System” is hereby incorporated by reference in its entirety.

A schematic diagram of a preferred embodiment of an apparatus according to the present invention is generally shown in FIG. 1. Exhaust gas 10 from a fluid transfer device 12, such as an extracorporeal blood oxygenator, travels to a gas measurement device 14. The gas measurement device 14 includes a microphone 16 that produces an electrical signal that may be amplified and converted to a digital signal via an analog/digital converter 18. The digital signal may be routed through a digital signal processor 20. This binary number is converted to a gas concentration using a look-up table 22, polynomial, or some other method known in the art. The gas concentration may then be corrected 24 using known variables such as barometric pressure, water vapor pressure, sweep gas flow, and blood flow to determine a partial gas pressure of a gas present in the exhaust gas. One correction algorithm for CO₂ according to the present invention is:
pCO_{2(OE)}=[CO₂]+{P_{B}−P_{W}}*{A+B*Q_{g}/Q_{b}+C*[Q_{g}/Q_{b}]²}
where:
A, B, and C are constants, with A approximately equal to 1, B approximately equal to 0.5, and C approximately equal to zero
CO_{2(OE)}=partial pressure of CO₂ in the exhaust of the fluid transfer device
[CO₂]=concentration of carbon dioxide determined from the look-up table/polynomial
P_{B}=barometric pressure in mmHg
P_{W}=water vapor pressure in mmhg
Q_{g}=sweep gas flow
Q_{b}=blood flow
   Sweep gas flow can be controlled via a Smart-Trak 100 brand mass flow controller from Sierra Instruments, Monterey, Calif. and blood flow rate can be measured with a blood flow monitor from Transonic Systems, Ithaca, N.Y. and regulated with a Biomedicus brand pump.

Once the partial pressure of CO₂ is determined, it can be displayed on a CRT or other display device in real time, stored in a memory array in real time, or otherwise communicated to a perfusionist. Other blood gases, such as O₂ or anesthesia, can also be measured, stored, and displayed in real time. Moreover, other parameters, such as blood flow, sweep rate, etc. can also be measured and stored in real time.

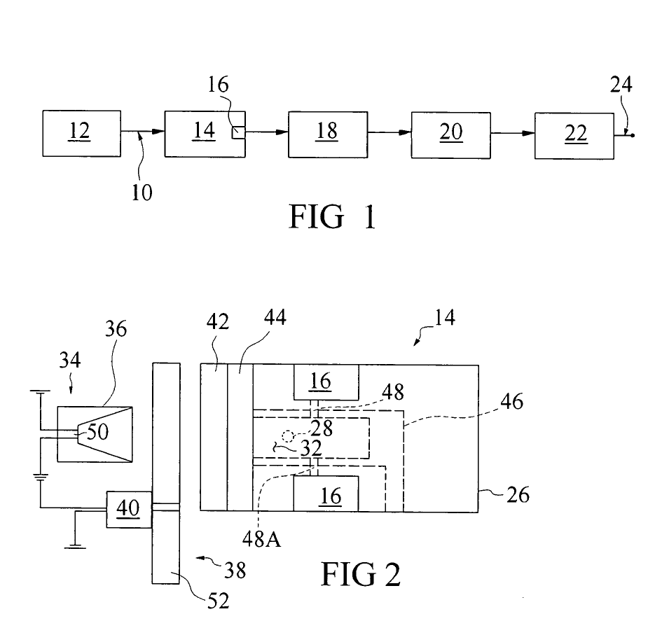

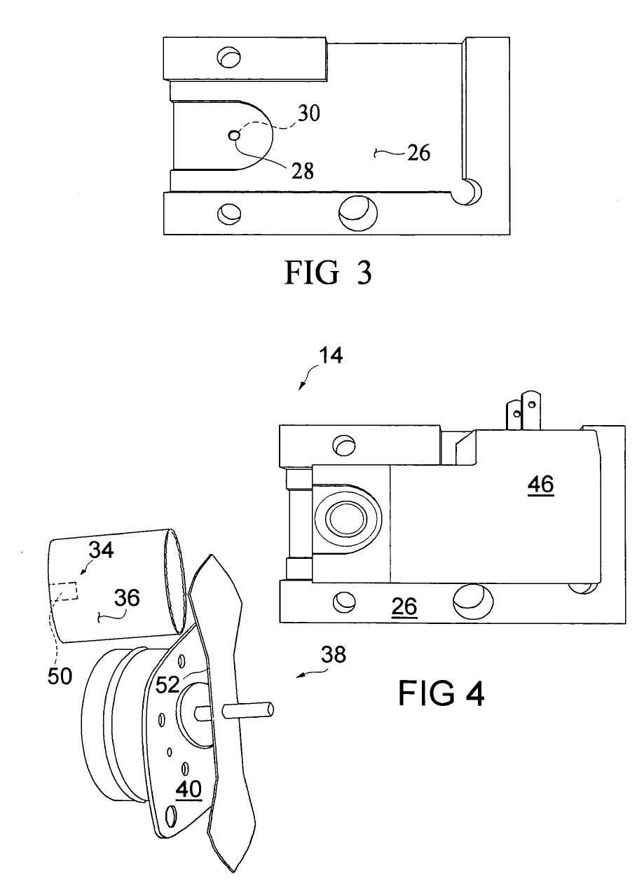

As shown in FIG. 2, the gas measurement device 14 in the preferred embodiment includes a body 26 that defines a gas inlet 28, a gas outlet 30 (FIG. 3), and a cavity 32 that defines a finite volume. The body 26 in the preferred embodiment is machined gold coated aluminum, but other suitable materials may be used. A thermal infrared source 34 or other excitation source and associated optics 36, a photo-interrupter 38 driven by a motor 40, an absorption filter cell 42 with infrared transmissive windows, an interference filter 44, a solenoid valve 46 or valves, detector microphones 16, and the gas inlet 28 and outlet 30 are pneumatically connected to the exposed cavity 32. The cavity 32 is fluidly sealed at the gas inlet 28 and gas outlet 30 by a corresponding solenoid valve 46. An exposed side of the cavity 32 is sealed by the interference filter 44 or the absorption filter cell 42, since the placement of these two items with respect to the body 26 can be reversed. One or more additional orifices 48, 48A, preferably offset opposed and fluidly connected to the cavity 32, are fluidly sealed by one or more microphones 16. The fluidly sealed cavity defines a finite volume that can be measured and recorded.

As shown in FIG. 4, the thermal infrared source 34 can use a nichrome iron alloy filament 50 positioned in reflective collection optics 36. For CO₂ detection, the thermal infrared source 34 can emit radiation with an absorbtion wavelength, with 4.3 microns being preferred. For isoflurane detection, the wavelength can increased to about 8 to 9 microns, with 8.5 microns being preferred. For other gases, the wavelength should be selected to approximately equal the gas absorption wavelength. Wavelength can be shifted, depending on the desired absorption wavelength of the gas to be detected, such as by elementary black body radiation equation R=σT⁴.

Referring again to FIG. 2, the photo interrupter 38, such as an optical chopper 52 driven by the motor 40, can be used to modulate the infrared signal. The interference filter 44 is designed to tailor the spectral content of the infrared source thereby reducing coincident absorption by other species while allowing maximum signal sensitivity with the required linearity. The gas filter cell 44 contains a gas mixture which removes the relevant wavelengths that would be absorbed by interferents. Optical filters are designed to minimize the effect of temperature on filter transmission, thus reducing spectral shift of the transmitted. Spectral shifts typically result in degradation of sensitivity, linearity, and selectivity by altering the absorption measurement by some means other than gas absorption. The solenoid valve 46 can be a Model CH-1290, commercially available from Fluid Automation Systems, Versoix, Switzerland. The detector microphones 16 commercially available from Sennheiser, Switzerland or Bruel Kjaer, Switzerland, can be selected based upon sensitivity and frequency response requirements.

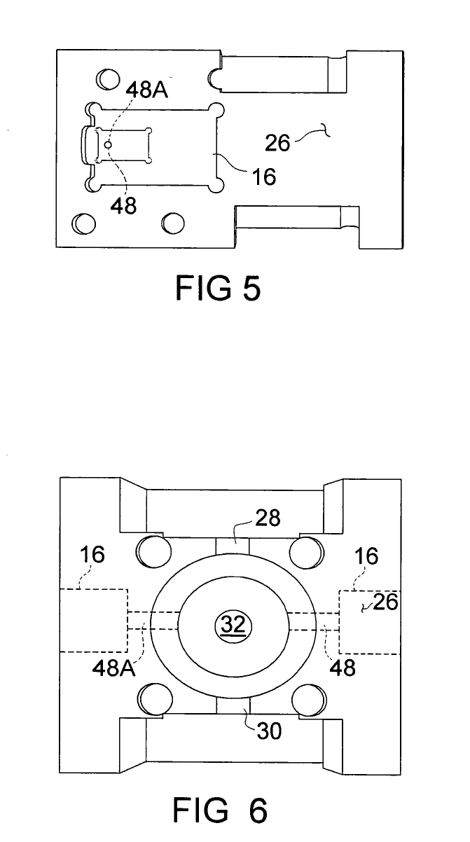

As shown in FIGS. 5 and 6, the microphones 16 can be placed on opposing sides of the body 26 to reduce the error associated with vibration. Each microphone 16 can be mounted on a printed circuit board and firmly secured in the body 26 to help define the finite cavity 32 in the body 26. The differential signal from the microphones 16 is proportional to the pressure within the cell while vibration induced signals appear as common mode noise and are removed by the detection system. The device may include a thermostat to ensure that potential variations in analyzer performance due to thermal effects are eliminated. Analyzer electronics can incorporate a programmable gain amplifier to provide the requisite gain, synchronous rectification bandwidth limiting techniques to reduce system noise, a Butterworth second-order low pass filter to remove residual high frequency noise, and an adjustable gain DC amplifier circuit can be used to scale the output to the appropriate level in the volts range. The apparatus according to the present invention can deliver a continuous flow of exhaust gas simultaneously to a prior art O₂ analyzer and a CO₂ analyzer described herein. A diaphragm pump can be used to draw flow from the exhaust gas line through a filter, an adjustable orifice, a small volume for pressure pulsation dampening, and finally through both the O₂ and CO₂ analyzers.

In one method of operation, exhaust gases from the fluid transfer device 12 enter the body 26 of the gas measurement device 14. Energy pre-selected to emit at a given wavelength is absorbed by a target gas or gas molecule. This absorption creates temperature increase of the target gas sealed in a fixed volume defined by the cavity 32. Infrared photons absorbed by the target gas increase overall gas temperature resulting in a pressure increase in a fixed volume which can be described by the ideal gas law PV=nRT. The pressure rise is measured with the microphone or microphones 16 and is proportional to the target gas concentration. The low offset drift, broad detection dynamic range, and robust nature of the microphone detection technique makes this the optimum technique for of a target gas, such as CO₂, in the exhaust gas exiting an extracorporeal oxygenator.

To determine a pCO2 gap, a blood gas analyzer, such as an ABL5 model commercially available from Radiometer, Copenhagen, Denmark may be used to take carbon dioxide blood gas readings from patient blood samples. Gas samples that are analyzed with the present invention can be correlated in time to the samples analyzed with the blood gas analyzer and the two results can be compared. If the gap is large, corrective actions can be taken by the perfusionists or other appropriate clinician. If the gap is sufficiently low or non-existent, the patient's perfusion status is normalized consistent with the conditions required to terminate cardiopulmonary bypass.

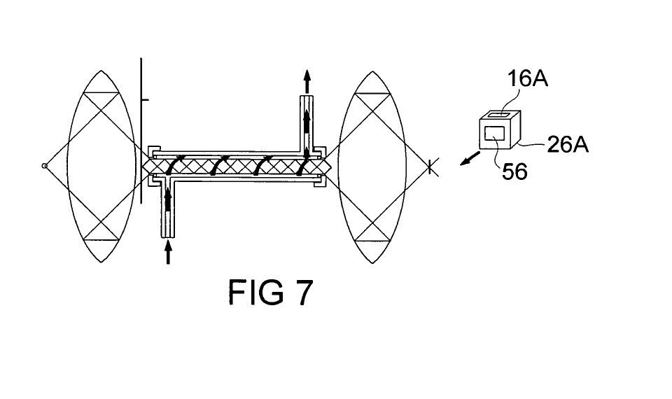

In another contemplated method of determining the CO2 gap, as shown in FIG. 7, a gas measurement device 26A according to the present invention is positioned in the optical termination path of an ATR device. In this embodiment, however, the gas measurement device is a sealed body 26A that contains a known volume of a target gas of interest, such as CO2, along with a microphone 16A and a transmission window 56. Solonoid or other suitable valves are not required.

IR selected at a pre-determined absorption wavelength propagates through the tube of the ATR device and is partially absorbed by a target gas present in the sample fluid. The IR exiting the tube thermally excites the fixed volume of target gas of interest, and the pneumatic sensor detects pressure variations in the fixed volume of target gas of interest. These pressure variations are then converted to a gas concentration and partial gas pressure, such as by the methods and apparatus discussed above. This gas concentration and partial pressure, measured in real-time, is then compared in real time to a gas concentration and partial pressure determined from the exhaust fluid analysis from another source, such as a blood oxygenator. The resulting difference is a gap, which can be stored or displayed in real-time. In summary, the present invention generally includes a system based on photo-acoustic analysis of the gases exiting an extracorporeal oxygenator as a real-time indicator of blood gas concentrations and partial pressures and methods of assessing the overall adequacy of perfusion. The present invention also allows perfusionists to immediately recognize a pCO₂ gap, allowing correction by changing parameters such as rate of rewarming, rate of blood flow, increasing perfusion pressure, or by altering the carrying capacity of blood by increasing hematocrit through blood transfusion.

The present invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

1. A method to determine blood gas concentrations and partial pressures in a patient, comprising the steps of:
exhausting at least one fluid from a fluid transfer device;
containing a fixed volume of the at least one fluid;
exposing the fixed volume of the at least one fluid to an excitation source; and
detecting a pressure change in the fixed volume of the at least one fluid.

2. The method as claimed in claim 1 wherein the step of exposing the fixed volume of the at least one fluid to the excitation source comprises the step of irradiating the fixed volume of the at least one fluid with infrared radiation having a wavelength equal to an absorption wavelength of at least one gas present in the fluid.

3. The method as claimed in claim 1 wherein the step of detecting the pressure change in the fixed volume of the at least one fluid comprises the step of creating an analog signal via a pneumatic sensor.

4. The method as claimed in claim 3 further comprising the step of amplifying the analog signal.

5. The method as claimed in claim 3 further comprising the step of converting the analog signal to a digital signal.

6. The method as claimed in claim 5 further comprising the step of sending the digital signal to a digital signal processor.

7. The method as claimed in claim 6 further comprising the step of converting the digital signal to a gas concentration via a look-up table or a polynomial, or some other algorithm.

8. The method as claimed in claim 7 further comprising the step of determining a partial pressure of the at least one gas present in the fluid.

9. The method as claimed in claim 8 wherein the at least one gas present in the fluid is carbon dioxide and the step of determining the partial pressure of the carbon dioxide further comprises the step of calculating a partial pressure of carbon dioxide according to some algorithm, one such equation
pCO_{2(OE)}=[CO2]+{P_{B}−P_{W}}*{A+B*Q_{g}/Q_{b}+C*[Q_{g}/Q_{b}]²}
where:
A, B, and C are constants, with A approximately equal to 1, B approximately equal to 0.5, and C approximately equal to zero
CO_{2(OE)}=partial pressure of CO₂ in an exhaust of a blood oxygenator
[CO₂]=concentration of carbon dioxide determined in claim 7
P_{B}=barometric pressure in mmHg
P_{W}=water vapor pressure in mmHg
Q_{g}=sweep gas flow
Q_{b}=blood flow

10. A method to determine a state of perfusion of a patient, comprising the steps of:
exhausting at least one fluid from a fluid transfer device;
containing a fixed volume of the at least one fluid;
exposing the fixed volume of the at least one fluid to an excitation source;
determining a first partial pressure or concentration of the at least one gas present in the fluid in real time;
determining a second partial pressure or concentration of the at least one gas present in the fluid via a device selected from the group comprising a blood blood gas analyzer, an ATR device, and an ATR device configured with a pneumatic sensor; and
comparing a difference between first partial pressure or concentration and the second partial pressure or concentration to determine a gap.

11. The method as claimed in claim 10, wherein the first partial pressure is determined in real time and the second partial pressure is matched, by time, to the first partial pressure.

12. The method as claimed in claim 10, wherein the at least one gas present in the fluid is carbon dioxide and further comprising the step of adjusting patient parameters until a partial pressure CO₂ gap is approximately zero.

13. An apparatus to determine a partial pressure of a gas, the apparatus comprising:
a gas measurement device body defining a cavity, wherein the cavity has a finite volume;
a microphone fluidly connected to the cavity; and
an excitation source in optically connected to the cavity.

14. The apparatus as claimed in claim 13, wherein the gas measurement device body defines a fluid inlet in communication with the cavity and further comprising a valve fluidly connected to the fluid inlet.

15. The apparatus as claimed in claim 13, further comprising a device connected to the gas measurement device body, the device selected from the group comprising a blood oxygenator exhaust fluidly connected to the cavity and a ATR device optically connected to the cavity.

16. The apparatus as claimed in claim 13 wherein the excitation source is an infrared radiation generator.

17. The apparatus as claimed in claim 13 further comprising a signal amplifier electrically connected to the microphone.

18. The apparatus as claimed in claim 13 further an analog to digital converter electrically connected to the microphone or amplifier.

19. The apparatus as claimed in claim 13 further comprising a digital signal processor electrically connected to the microphone.

20. The apparatus as claimed in claim 13 further comprising an interference filter positioned adjacent to the gas measurement device body.
